(19) United States
(12) Patent Application Publication
(10) Pub. No.: US 2011/0287789 A1
(43) Pub. Date: Nov. 24, 2011

(54) METHOD AND APPARATUS FOR RECOGNITION OF DEVICES

(75) Inventors: Daiqin Yang, Singapore (SG); Yong Liu, Shanghai (CN); Lei Feng, Shanghai (CN); Zhigang Chen, Shanghai (CN)

(73) Assignee: Koninklijke Philips Electronics N.V., Eindhoven (NL)

(21) Appl. No.: 13/131,898

(22) PCT Filed: Nov. 26, 2009
(86) PCT No.: PCT/IB2009/055347

§ 371 Date: Aug. 15, 2011

(30) Foreign Application Priority Data
Dec. 5, 2008 (CN) 200810177115.2

(51) Int. Cl. H04W 4/00

(52) U.S. Cl. 455/500

(57) ABSTRACT

The present invention aims to provide a technical solution for recognizing a target device from a plurality of devices as follows: sending a first and second wireless signal to a plurality of devices and determining the target device according to the signal strength differences between the first and second signal strengths. By using the technical solutions of the present invention, the “near-far-effect” caused by a single antenna can be overcome, and different offsets in the measured received signal strengths caused by the diversity of the receiving antennas can also be eliminated, and thus the accuracy of recognition is improved efficiently.

### FIELD OF THE INVENTION

The present invention relates to recognition of devices, particular to recognizing devices via the signal strength of the wireless signals received by devices.

### BACKGROUND OF THE INVENTION

Currently, wireless lighting control is becoming more and more popular with the deployment of ZigBee™, Bluetooth™, and other wireless protocols. However, there still lacks an effective mechanism for directional control. For example, with directional control, users can control a light, such as controlling the turning on/off and light intensity, through “pointing” to it.

Directional control is helpful in large rooms where there are many lights installed. For example, in a large meeting room, the presenter may want to turn off the lights close to the projector screen, while turning on the other lights. With directional control, the presenter can remain at his position and simply point the hand-held controller to the light he wants to control, and then turn it on or off.

The most straightforward way to enable wireless directional control is to use directional antenna and distinguish lights by their different received signal powers. However, when a directional antenna is adopted, there exists a defect called “near-far effect”. That is, although directional antenna may induce a higher received signal power at the light that it points to, the lights near the controller may also have very high received signal power due to the very short propagation distance. Thus it is difficult to determine which light the user actually wants to control merely based on the signal strength. Moreover, the diversity of the antennas installed in the lights may also introduce different offsets in the measured received signal strength and thus introduce errors into the recognition.

FIG. 1 illustrates a typical radiation pattern of a directional antenna in different directions. The power gain of the directional antenna in different directions is denoted as G (θ,φ) (simply referred as “directional gain” hereinafter). Suppose the transmitting power is P_{T}, the actual power received by a receiver not only depends on the transmitting power P_{T} and the gain of the transmitting antenna, but also depends on other factors such as the gain of the receiving antenna, the distance, the frequency of the wireless signals, etc. The signal strength difference of two wireless signals respectively received by two lights not only depends on the gain of the transmitting antenna, but also depends on the gain of the two receiving antennas and the distances between the two receiving antennas and the transmitting antennas. In other words, if the signal strength of a wireless signal received by light R1 is greater than that of light R2, it cannot be concluded that light R1 is located in the direction of the maximal radiation of the transmitting antenna or light R1 is the target light the subscriber wants to control.

### SUMMARY OF THE INVENTION

To solve the above issues, there is provided in an embodiment of the present invention a technical solution for recognizing a target device from a plurality of devices as follows: sending a first and a second wireless signals to a plurality of devices and determining the target device according to the signal strength differences between the first and second signal strengths.

According to an embodiment of the present invention, there is provided a method for recognizing a target device. The method comprises the steps of: sending a first and second wireless signal to a plurality of devices; obtaining, from each device, a first and a second signal strengths respectively representing the signal strength of the first and the second wireless signals received by the device, or a signal strength difference between the first and the second signal strengths; and determining the target device according to the obtained signal strengths or the signal strength differences.

According to an embodiment of the present invention, there is provided a wireless controller for recognizing a target device. The wireless controller comprises a first transmitter, an obtainer and a determiner. The first transmitter is configured to send a first and a second wireless signals to a plurality of devices. The obtainer is configured to obtain, from each device, a first and a second signal strength respectively representing the signal strength of the first and the second wireless signals received by the device, or a signal strength difference between the first and the second signal strengths. The determiner is configured to determine the target device according to the obtained signal strengths or the obtained signal strength differences.

Preferably, the first transmitter of the wireless controller comprises an omnidirectional antenna, a first directional antenna and a first controller, wherein the first controller controls the omnidirectional antenna and the first directional antenna to respectively send the first and second wireless signals to the plurality of devices.

Preferably, the first transmitter of the wireless controller comprises a second directional antenna and a second controller, wherein the second controller controls the second directional antenna to send the first and second wireless signals to the plurality of devices by way of symmetrically deviating a predetermined angle from a predetermined direction.

Preferably, the first transmitter of the wireless controller comprises a third directional antenna, a fourth directional antenna and a third controller, wherein, the third controller controls the third directional antenna and the fourth directional antenna to respectively send the first and second wireless signals to the plurality of devices in a way of symmetrically deviating a predetermined angle from a predetermined direction.

According to an embodiment of the present invention, there is provided a device comprising a receiver, a determiner and a second transmitter, wherein the receiver is configured to receive two wireless signals sent by a wireless controller; the determiner is configured to determine the signal strength of the two wireless signals or their difference; the second transmitter is configured to send the signal strength or their difference to the wireless controller.

By using the technical solutions of the present invention, the “near-far-effect” caused by a single antenna can be overcome, and different offsets in the measured received signal strengths caused by the diversity of the receiving antennas can also be eliminated, and thus the accuracy of recognition is improved efficiently.

### BRIEF DESCRIPTION OF THE DRAWINGS

Other purpose, aspects and advantages of the present invention will become clear and prominent after reading the description with reference to the accompanying drawings, in which identical reference numerals denote identical or like components:

FIG. 1 shows a schematic view of the power gain of a directional antenna in different directions;

FIG. 2 shows a scenario of an embodiment of the present invention;

FIG. 3 shows a schematic flow chart of the method of recognizing a target device from a plurality of device 23 according to another embodiment of the present invention;

FIG. 4 shows a block diagram of the first transmitter of the wireless controller 21 according to one embodiment of the present invention;

FIGS. 5(a) and 5(b) respectively show schematic views of the beam forming of an omnidirectional antenna and a directional antenna according to one embodiment of the present invention;

FIG. 6 shows the flow chart of the sub-steps of step S301 shown in FIG. 3;

FIG. 7 shows another block diagram of the first transmitter of the wireless controller 21 according to one embodiment of the present invention;

FIG. 8 shows a schematic view of the beam forming of a second adjustable-beam directional antenna 71;

FIGS. 9(a) and 9(b) respectively show schematic views of the beam forming of the second adjustable-beam antenna 71 with its maximum radiation being upward and downward oriented by the same predefined angle along the axis Z;

FIG. 10 shows the schematic view of the transmitting power gain of the first and second wireless signals.

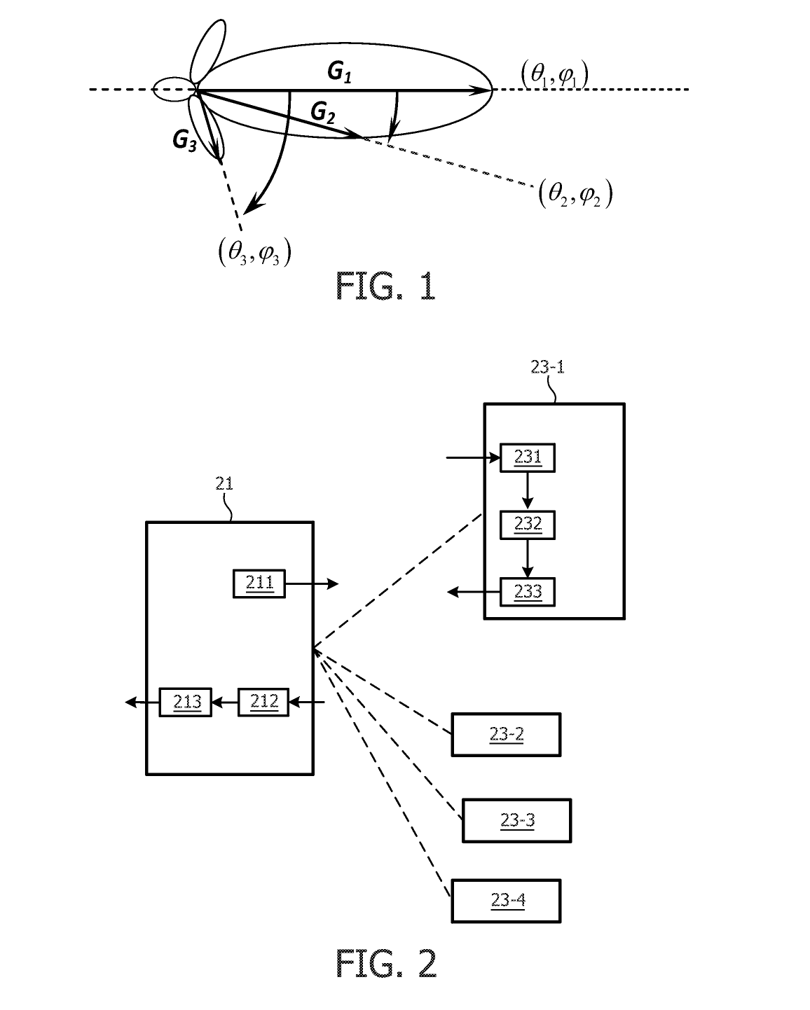

### DETAILED DESCRIPTION

FIG. 2 shows a schematic view of a scenario of an embodiment of the present invention. There are a wireless controller 21 and four devices 23-1, 23-2, 23-3 and 23-4 in FIG. 2. For simplicity, FIG. 2 only shows four devices, but those skilled in the art should understand that the number of the devices is not limited. And the device 23 may be any controllable devices, such as luminaries etc.

In FIG. 2, the wireless controller 21 comprises a first transmitter 211, an obtainer 212 and a first determiner 213. Each device comprises a receiver 231, a second determiner 232 and a second transmitter 233.

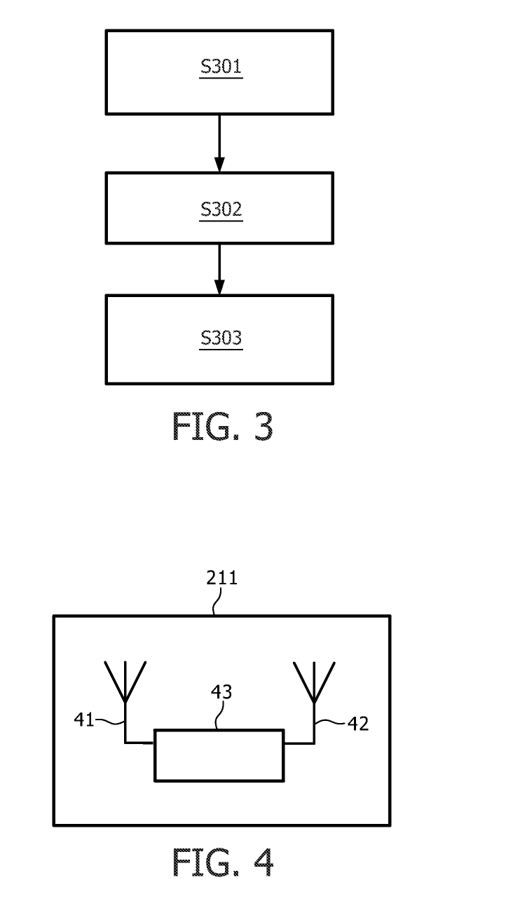

FIG. 3 shows a schematic flow chart of the method of the wireless controller 21 recognizing a target device from a plurality of devices 23 according to another embodiment of the present invention. The flowchart of FIG. 3 will be described in detail below in conjunction with the scenario of FIG. 2.

Firstly, in step S301, the first transmitter 211 of the wireless controller 21 sends a first and second wireless signal to a plurality of devices 23.

Then, in step S302, the obtainer 212 of the wireless controller 21 obtains a first and second signal strength respectively representing the signal strength of the first and second wireless signal received by each device, or a signal strength difference between the first and the second signal strengths.

Specifically, step S302 can be implemented in several ways. For example, after each device 23 receives the first and second wireless signals transmitted by the wireless controller 21, the second determiner 232 determines a signal strength difference between the first and second signal strengths, and then the second transmitter 233 sends the signal strength difference to the wireless controller 21.

Below is another example of the implementation of step S302. The second determiner 232 of each device 23 determines the signal strength of the first and second wireless signals received respectively, and then the second transmitter 233 sends the signal strength of the first and second signals to the wireless controller 21. The wireless controller 21 computes the difference between the signal strengths of the first and second signals. Or each device 23 may send the signal strength of the first and second signals to another item of equipment, the equipment may compute the difference between the signal strengths of the first and second signals and send the difference to the wireless controller 21.

Lastly, in step S303, the first determiner 213 of the wireless controller 21 determines the target device according to the signal strengths of the first and second signals or their difference for each device 23 obtained by the obtainer 212. In step S303, the first determiner 213 determines as being the target device the device corresponding to the maximum or minimum signal strength difference among all the signal strength differences or the two signal strengths having the maximum or minimum signal strength difference, according to the way of sending the first and second signals. This will be described in detail later.

Preferably, before step S301 shown in FIG. 3, the wireless controller 21 can receive operation instructions which triggers step S301 and its subsequent steps. These operation instructions may be sent by users or other devices (not shown in FIG. 2). For example, once a projector is turned on, it may send a signal to the wireless controller 21 for indicating turning off the lights close to the projector screen.

It should be noted that the operation instruction is not the only way to trigger step S301 and its subsequent steps. In some automatic tests, the wireless controller 21 can also trigger step S301 and its subsequent steps by automatic detection of the existence of items of equipment by way of infrared detection etc.

After the first determiner 231 of the wireless controller 21 has determined the target device, the wireless controller 21 sends the received operation instructions to the operation apparatus of the target device (not shown in FIG. 2). The operation apparatus executes the corresponding operations against the target device according to the operation instructions. For example, the device 23 is a light, its corresponding operation apparatus includes a switch or a brightness adjustment apparatus etc.

In the following section, the detailed procedures of sending the first and second wireless signals by the first transmitter 211 of the wireless controller 21 will be exemplarily described.

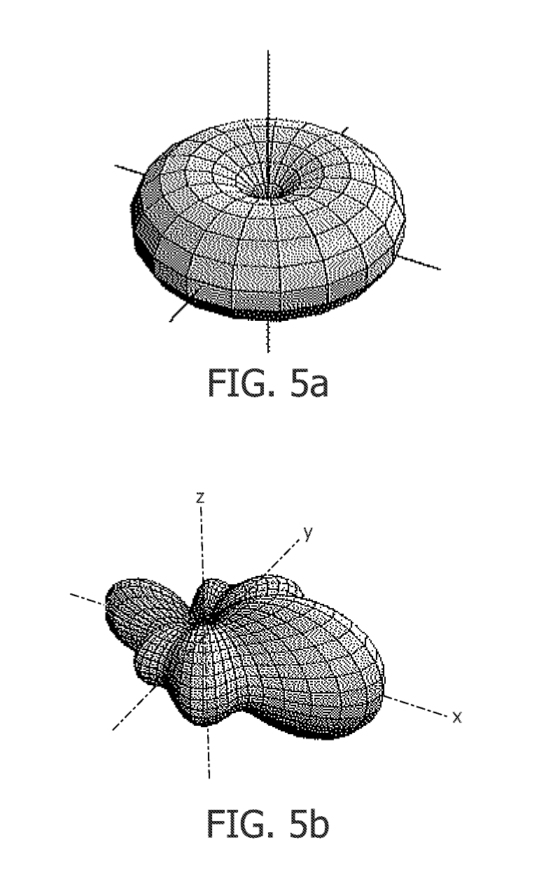

FIG. 4 shows a block diagram of the first transmitter 221 according to one embodiment of the present invention. The first transmitter 211 comprises an omnidirectional antenna 41, a first directional antenna 42 and a first controller 43. FIGS. 5(a) and 5(b) respectively show schematic views of the beam forming of the omnidirectional antenna 41 and the directional antenna 42.

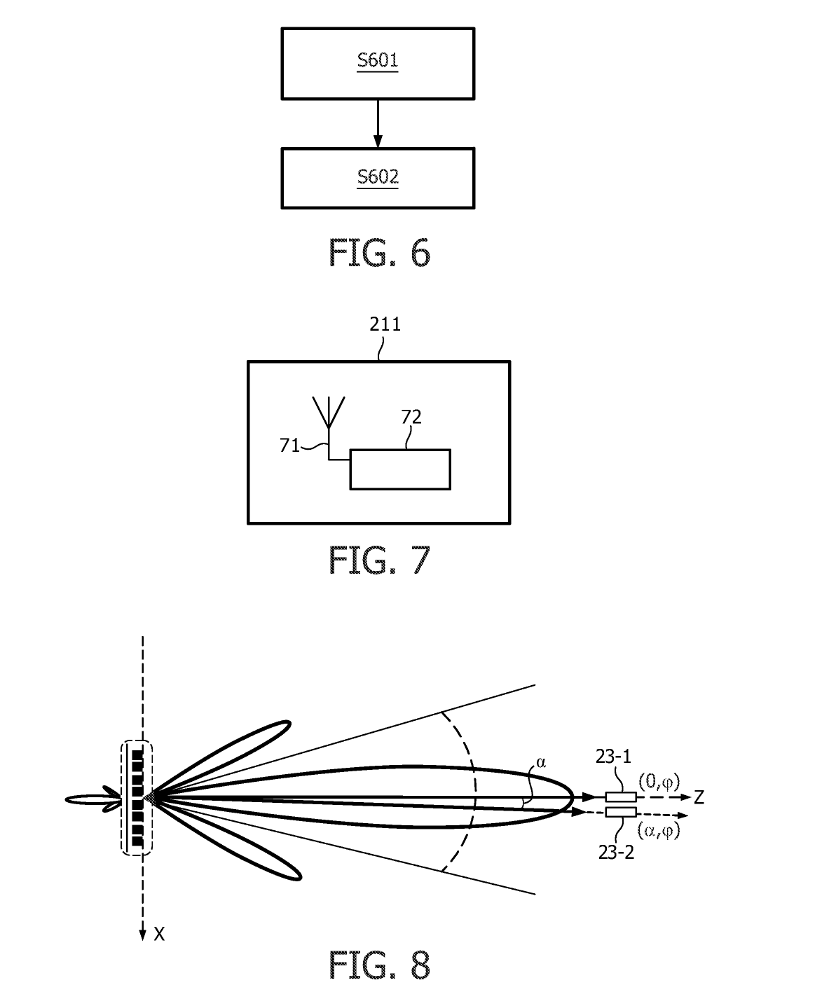

Below, an embodiment of sending the first and the second wireless signals by the first transmitter 211 to the plurality of devices 23 in step S301 will be described. FIG. 6 shows a flow chart of sub-steps of step S301.

Firstly, in step S601, the first controller 43 controls the omnidirectional antenna 41 to send the first wireless signal to the plurality of devices 23.

Preferably, the first controller 43 may comprise a microcontroller and a RF control chip. The microcontroller controls the omnidirectional antenna to send the first wireless signal via the RF control chip.

The first wireless signal has the signal features which can be recognized by each device 23. For example, the first signal may have a predefined frame structure that contains a preamble code and a flag indicating that the first wireless signal is sent by the omni-directional antenna 41 for measuring the signal strength and so on. The first wireless signal may comprise one or multiple wireless signals. If the first wireless signal comprises multiple wireless signals, each wireless signal of the multiple signals may further comprise the information on the amount of first wireless signal, the sequence number of the current signal etc.

Then, instep S602, the first controller 43 controls the first directional antenna 42 to send the second wireless signal to the plurality of devices 23, wherein the maximum power gain direction of the first directional antenna 42 substantially points to the target device.

It should be noted that, if the operation instruction is sent by a user, the “pointing” action can be done by the user before the first and the second wireless signals are sent by the wireless controller 21. For example, the user makes the wireless controller 21 point to the device that the user wants to control (the controller may indicate to the user that the wireless controller has pointed to the device via a laser beam), and then presses a button to send the corresponding operation instruction.

If an operation instruction is sent by other devices or the wireless controller 21 triggers the transmission process automatically, the “pointing” action can be done automatically by the wireless controller 21.

Similarly to the first wireless signal, the second wireless signal also has the signal features that can be recognized by each device 23. For example, the second signal may have a predefined frame structure that contains a preamble code and a flag indicating that the second signal is sent by the first directional antenna 42 for measuring the signal strength and so on. The second wireless signal may comprise one or multiple wireless signals. If the second wireless signal comprises multiple wireless signals, each wireless signal of the multiple wireless signals may further comprise the information on the amount of the second wireless signal, the sequence number of the current signal etc.

If the first and second wireless signals comprise multiple wireless signals, the signal strengths of the first and second signals received by the device 23 comprise the mean or weighted mean of the signal strengths of the received multiple wireless signals. The value of the weighted coefficients can be selected based on experience values of the actual system. By using multiple wireless signals in the first and second signals, the interference of some sudden accidental factors (e.g. burst noise) can be reduced, the stability and robustness of the system can be enhanced and the accuracy of the recognition result can be increased.

Preferably, the first and second wireless signals may be orthogonal. The meaning of orthogonality comprises different orthogonal ways, such as being orthogonal in time, being orthogonal in frequency, Code Division Multiple Access or arbitrary combination among them etc. For multiple signals in the first or second signals, they should also be orthogonal to each other, including being orthogonal in time, being orthogonal in frequency, Code Division Multiple Access or any combination among them etc.

It should be noted that if the first and second wireless signals are not orthogonal to each other in time, e.g. being orthogonal in frequency or Code Division Multiple Access, there is no sequence between step S601 and S602 as shown in FIG. 6. They can be performed at the same time or at different times. Even if only orthogonality in time is adopted, there is also no sequence between the two steps except that they cannot be performed at the same time.

After that, the obtainer 212 of the wireless controller 21 obtains, from each device 23, a signal strength difference between the first and second signal strengths. Then the first determiner 213 determines as being the target device the device corresponding to the minimum difference among all the signal strength differences computed by subtracting the signal strength of the second wireless signal from that of the first wireless signal or the maximum difference among all the signal strength differences computed by subtracting the signal strength of the first wireless signal from that of the second wireless signal.

Below, the procedure that the first determiner 213 of the wireless controller 21 determines the target device corresponding to the maximum or minimum signal strength differences of the first and second wireless signals will be analyzed.

Without loss of generality, the receiver 231 of the device 23-1 and 23-2 comprises a receiving antenna and a control chip. The form and the gain of the receiving antennas are not limited and also no similarity is required. In addition, optionally, the first and second wireless signals comprise only one wireless signal.

Then the signal strengths of the first wireless signal sent by the omnidirectional antenna 41 and received by the device 23-1 and 23-2 can be represented by the following two formulae:

$$\begin{matrix}{P}_{R 1}^{O} ( dBm ) = {P}_{T}^{O} ( dBm ) + 20 lg \frac{c}{4 π} + 10 {lgG}_{T}^{O} + 10 {lgG}_{R 1} - 20 lg {d}_{1} - 20 lg {f}_{O} & ( 1 ) \\ {P}_{R 2}^{O} ( dBm ) = {P}_{T}^{O} ( dBm ) + 20 lg \frac{c}{4 π} + 10 {lgG}_{T}^{O} + 10 {lgG}_{R 2} - 20 lg {d}_{2} - 20 lg {f}_{O} & ( 2 )\end{matrix}$$

wherein P_{R1}^{o} and P_{R2}^{o} are signal strengths of the first wireless signal sent by the omnidirectional antenna 41 and received by the device 23-1 and 23-2 respectively, P_{T}^{o} is the transmitting power of the omnidirectional antenna 41, G_{T}^{O} is the gain of the omnidirectional antenna 41, G_{R1} and G_{R2} are the gains of the receiving antennas of the receiver 231 of the device 23-1 and 23-1 respectively, d₁ and d₂ are the distance between the omnidirectional antenna 41 and the receiving antenna of the device 23-1 and 23-2 respectively, and f_{O} is the frequency of the first wireless signal sent by the omni-directional antenna 41.

The signal strength of the second wireless signal sent by the first directional antenna 42 and received by the device 23-1 and 23-2 can be represented by the following two formulae:

$$\begin{matrix}{P}_{R 1}^{D} ( dBm ) = {P}_{T}^{D} ( dBm ) + 20 lg \frac{c}{4 π} + 10 {lgG}_{T}^{D} ( {θ}_{1} , {ϕ}_{1} ) + 10 {lgG}_{R 1} - 20 lg {d}_{1} - 20 lg {f}_{D} & ( 3 ) \\ {P}_{R 2}^{D} ( dBm ) = {P}_{T}^{D} ( dBm ) + 20 lg \frac{c}{4 π} + 10 {lgG}_{T}^{D} ( {θ}_{2} , {ϕ}_{2} ) + 10 {lgG}_{R 2} - 20 lg {d}_{2} - 20 lg {f}_{D} & ( 4 )\end{matrix}$$

wherein P_{R1}^{D} and P_{R2}^{D} are signal strengths of the second wireless signal sent by the first directional antenna 42 and received by the receiving antennas of the device 23-1 and 23-2 respectively, P_{T}^{D} is the transmitting power of the first directional antenna 42, and G_{T}^{D}(θ₁,φ₁) and G_{T}^{D}(θ₂,φ₂) are the directional gains from the first directional antenna 42 to the receiving antennas of the device 23-1 and 23-2 respectively. As the receiving antennas of the device 23-1 and 23-2 remain unchanged, G_{R1}, G_{R2}, d₁ and d₂ in formulae (3) and (4) has the same meaning as in formulae (1) and (2). f_{D} is the frequency of the second wireless signal sent by the first directional antenna 42. f_{O} and f_{D} can be the same or can be different.

By subtracting formula (1) from formula (3), and subtracting formula (2) from formula (4), the following formulae (5) and (6) are obtained:

P_{R1}^{D}(dBm)−P_{R1}^{O}(dBm)=P_{D}^{T}(dBm)−P_{T}^{O}(dBm)+101gG_{T}^{D}(θ₁,φ₁)−101gG_{T}^{O}−201gf_{D}+201gf_{O} (5)

P_{R2}^{D}(dBm)−P_{R2}^{O}(dBm)=P_{T}^{D}(dBm)−P_{T}^{O}(dBm)+101gG_{T}^{D}(θ₂,φ₂)−101gG_{T}^{O}−201gf_{D}+201gf_{O} (6)

By subtracting formula (6) from formula (5), formula (7) is obtained:

[P_{R1}^{D}(dBm)−P_{R1}^{O}(dBm)]−[P_{R2}^{D}(dBm)−P_{R2}^{O}(dBm)]=101gG_{T}^{D}(θ₁,φ₁)−101gG_{T}^{D}(θ₂,φ₂) (7)

As can be seen from formula (7), the terms on the right-hand side of the equation are only relevant to the directional gain of the first directional antenna 42. For example, when a user is using the wireless controller 21, the desired target device is always located in the maximum radiation direction of the first directional antenna 42 of the wireless controller 21. Therefore it can be judged according to formula (7) that if the device 23-1 is the target device, the right-hand part of formula (7) is always positive, i.e. as compared with other devices, the signal strength difference computed by subtracting the signal strength of the first wireless signal received by the target device from the signal strength of the second wireless signal received by the target device is maximum or the signal strength difference computed by subtracting the signal strength of the second wireless signal received by the target signal from the signal strength of the first wireless signal received by the target device is minimum.

Therefore, after the obtainer 212 has obtained the signal strength differences between the first and the second wireless signals received by each device 23, the first determiner 213 can determine the device corresponding to the maximum signal strength difference among all the signal strength differences computed by subtracting the received signal strength of the first wireless signal from that of the second wireless signal or the minimum signal strength difference among all the signal strength differences computed by subtracting the received signal strength of the second wireless signal from that of the first wireless signal as the target device.

It should be noted that the aforementioned omnidirectional antenna 41 is only quasi omnidirectional. In practice, it is impossible to make the omnidirectional antenna 41 have exactly the same gain in all directions. However, even if some differences are introduced to the gains of the omnidirectional antenna 41 in different directions, the above deduction still holds. The detailed analysis will be described as follows.

If some differences are introduced to the gains of the omni-directional antenna 41 in different directions, the formula (7) can be rewritten as:

[P_{R1}^{D}(dBm)−P_{R1}^{O}(dBm)]−[P_{R2}^{D}(dBm)−P_{R2}^{O}(dBm)]=[101gG_{T}^{D}(θ₁,φ₁)−101gG_{T}^{D}(θ₂,φ₂)]−[101gG_{T}^{O}(θ₁,φ₁)−101gG_{T}^{O}(θ₂,φ₂)] (8)

wherein G_{T}^{O}(θ₁,φ₁) and G_{T}^{O}(θ₂, φ₂) are the gains of the omnidirectional antenna 41 in the direction from the omnidirectional antenna 41 to the device 23-1 and 23-2 respectively. In practice, the diversity of the omnidirectional antenna 41 in different directions is far smaller than that of the first directional antenna 42. Therefore, if the device 23-1 is the target device, the right-hand part of the formula is always positive and the above deduction still holds.

FIG. 7 shows another block diagram of the first transmitter 211 of the wireless controller 21 according to another embodiment of the present invention. In FIG. 7, the first transmitter 211 comprises a second directional antenna 71 adjustable in the beam direction and a second controller 72. The schematic view of the beam forming of the second directional antenna 71 may refer to FIG. 5(b).

Another embodiment of sending the first and second signals from the first transmitter 211 of the wireless controller 21 to the plurality of devices 23 in step S301 will be described below.

The second controller 72 controls the second directional antenna 71 to send the first and second wireless signals to the plurality of devices 23 by way of symmetrically deviating a predefined angle from a predefined direction. Preferably, the predefined direction is the direction that is the maximum radiation direction of the second directional antenna 71 pointing to the target device. For example, when a user is using the wireless controller 21, he usually makes the wireless controller 21 point to the device he wants to control and then sends a command by an action such as pressing a key. In some automatic tests, the “pointing” action can also be done by the wireless controller 21.

Specifically, the second controller 72 adjusts the beam direction of the second directional antenna 71 to make the maximum radiation direction of the second directional antenna deviate by a predefined angle θ from the predefined direction. Then the second controller 72 controls the second directional antenna 71 to send the first wireless signal to the plurality of devices 23. After that, the second controller 72 controls the second directional antenna 71 to make its maximum radiation direction deviate by a predefined angle θ from the predefined direction in the opposite direction relative to the direction of sending of the first signal, and then sends a second wireless signal to the plurality of devices 23. The predefined angle θ is usually a small angle, and its value depends on the actual wireless controller 21 and the property of the antennas of the devices 23 (e.g. the beam forming property of the adjustable directional antennas).

Preferably, the functions of the second controller 72 can be implemented by the microcontroller and the RF control chip.

After that, the obtainer 212 obtains the signal strength differences between the first and second wireless signals received by each device 23. Then the first determiner 213 determines as being the target device the device corresponding to the signal strength difference having the minimum absolute among all the signal strength differences of the plurality of devices 23.

The procedure that the first determiner 213 determines the device corresponding to the signal strength difference having the minimum absolute among all the signal strength differences will be analyzed below. Without loss of generality, still suppose that the first and second wireless signals comprise only one wireless signal.

To facilitate the description, the aforementioned procedure will be analyzed with the example of the direction control in the X-Z plane. Those skilled in the art should understand that the analysis in the X-Y plane or in the Y-Z plane is the same as that in the X-Z plane.

FIG. 8 shows a schematic view of the beam forming of a second adjustable-beam directional antenna 71. The devices 23-1 and 23-2 are located in two different directions in the X-Z plane, and their angular distance from the second directional antenna 71 is α. Without loss of generality, suppose the device 23-1 is the target device and located in the maximum radiation direction of the second directional antenna 71 with its beam forming not being adjusted, namely the predefined direction. The angular coordinates of the device 23-1 and 23-2 are (0,φ) and (α,φ) respectively.

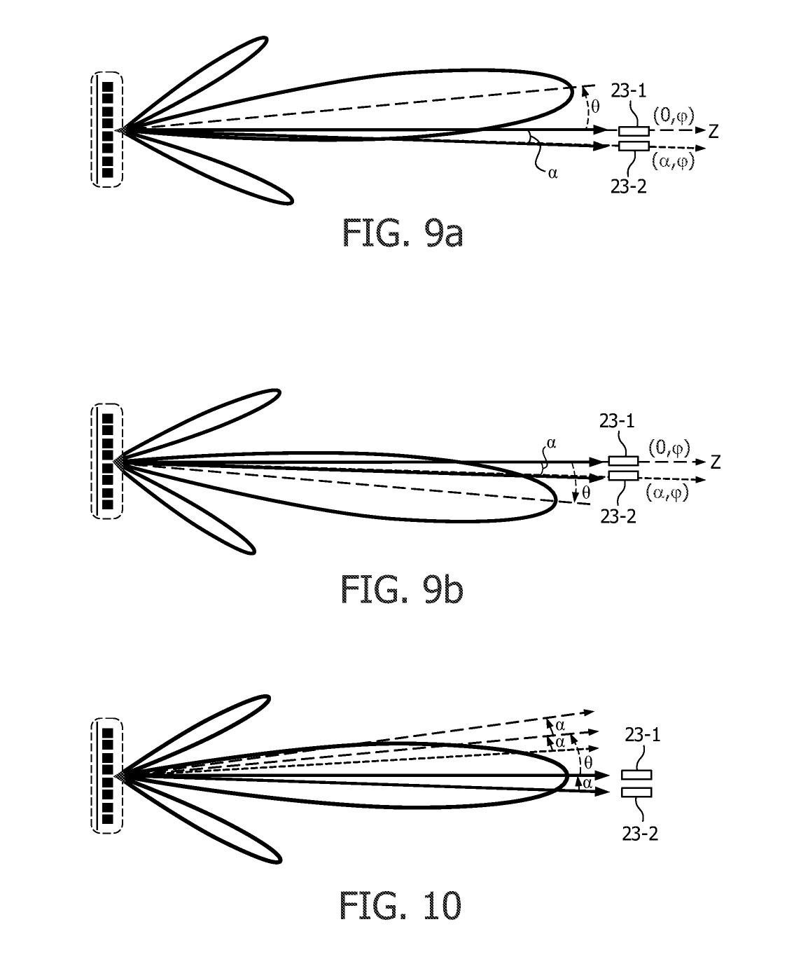

FIGS. 9(a) and 9(b) respectively show schematic views of the beam forming of the second adjustable-beam antenna 71 with its maximum radiation being upward and downward oriented by the same predefined angle along the axis Z. According to antenna theory, the gain of the second directional antenna 71 in the maximum radiation direction changes little or remains almost unchanged when its beam forming is adjusted by a small angle. And the gains of the second directional antenna 71 are symmetric to its maximum radiation direction. By using this property, the gains of the transmitting antenna of the first and second wireless signals received by the device 23-1 are G_{T}(θ,φ) and G_{T}(θ,φ) respectively, and gains of the transmitting antenna of the first and second wireless signals received by the device 23-2 are G_{T}(θ+α,φ) and G_{T}(θ−α,φ) respectively, as shown in FIG. 10.

Under the circumstances shown in FIG. 9(a), the signal strengths of the first wireless signal received by the devices 23-1 and 23-2 can be expressed as the formulae (9) and (10) respectively:

$$\begin{matrix}{P}_{R {1}^{′}} = {P}_{T} + 20 lg \frac{c}{4 π} + 10 {lgG}_{T} ( θ , ϕ ) + 10 {lgG}_{R 1} - 20 lg d 1 - 20 {lgf}_{{D}^{′}} & ( 9 ) \\ {P}_{R {2}^{′}} = {P}_{T} + 20 lg \frac{c}{4 π} + 10 {lgG}_{T} ( θ + α , ϕ ) + 10 {lgG}_{R 2} - 20 lg d 2 - 20 lg {f}_{{D}^{′}} & ( 10 )\end{matrix}$$

Wherein P_{R1′} and P_{R2′} are the signal strengths of the first wireless signal sent by the second directional antenna 71 and received by the receiving antenna of the device 23-1 and 23-2 respectively, P_{T} is the transmitting power of the second directional antenna 71, G_{R1} and G_{R2} are gains of the receiving antenna of the device 23-1 and 23-2 respectively, d₁ is the distance between the second directional antenna 71 and the receiving antennas 231-1 of the device 23-1, d₂ is the distance between the second directional antenna 71 and the receiving antennas 231-2 of the device 23-2, and f_{D′} is the frequency of the wireless signal sent by the second directional antenna 71.

Under the circumstances shown in FIG. 9(b), the signal strengths of the second wireless signal received by the devices 23-1 and 23-2 can be expressed as the formulae (11) and (12) respectively:

$$\begin{matrix}{P}_{R {1}^{″}} = {P}_{T} + 20 lg \frac{c}{4 π} + 10 {lgG}_{T} ( θ , ϕ ) + 10 {lgG}_{R 1} - 20 lg d 1 - 20 {lgf}_{{D}^{′}} & ( 11 ) \\ {P}_{R {2}^{″}} = {P}_{T} + 20 lg \frac{c}{4 π} + 10 {lgG}_{T} ( θ - α , ϕ ) + 10 {lgG}_{R 2} - 20 lg d 2 - 20 lg {f}_{{D}^{′}} & ( 12 )\end{matrix}$$

Wherein P_{R1″} and P_{R2″} are the signal strengths of the second wireless signal sent by the second directional antenna 71 and received by the receiving antenna of the devices 23-1 and 23-2 respectively.

By subtracting formula (9) from formula (11) and formula (10) from formula (12), formulae (13) and (14) are obtained:

P_{R1″}−P_{R1′}=0 (13)

P_{R2″}−P_{R2′}=101gG_{T}(θ−α,φ)−101g_{T}(θ+α,φ) (14)

As can be seen from formulae (13) and (14), the signal strength difference between the first and the second wireless signals received by the device 23-1 or 23-2 is not relevant to the gain of the receiving antenna, and not relevant to the distance between the second directional antenna 71 and the receiving antenna of the device 23-1 or 23-2 either, and is relevant only to the direction of the device 23-1 or 23-2 relative to the direction of the first transmitter 211 and the directional gain of the second directional antenna 71.

As can be seen from formulae (13) and (14), as compared with other devices, the absolute signal strength difference between the first and second wireless signals received by the target device is the smallest. Therefore, after the obtainer 212 has obtained the signal strength differences between the first and second wireless signals received by each device 23, the first determiner 213 can determine as being the target device the device corresponding to the minimum absolute signal strength difference among all the signal strength differences computed by subtracting the strength difference of the second wireless signal from that of the first wireless signal.

In consideration of the side lobe effect of the directional gain of the second directional antenna 71, in order to further increase the accuracy of the recognition, the second controller 72 can further control the second directional antenna 71 to send a third wireless signal to the plurality of devices 23 so that the maximum radiation direction of the second directional antenna 71 points to the target device.

After the receiver 231 of each device 23 receives the third wireless signal, the second determiner 232 determines the signal strength of the third wireless signal, which is also referred as the third signal strength. And then the second transmitter 233 sends the third signal strength to the wireless controller 21.

Similar to the first and second wireless signals, the third wireless signal also has the signal features that can be recognized by each device 23, e.g. a predefined frame structure that contains a preamble code and a flag indicating that the third wireless signal is sent by the second directional antenna 71 for measuring the signal strength etc. The frame structure of the third wireless signal can be the same as that of the first or second wireless signal, and of course they can be different. The third wireless signal can comprise one or multiple wireless signals. If the third wireless signal comprises multiple wireless signals, each wireless signal of the multiple wireless signals can further comprise the information on the amount of the third wireless signals, the sequence number of the current signal etc.

If the third wireless signal comprises multiple wireless signals, the signal strength of the third wireless signal received by each device 23 comprises the mean or weighted mean of the signal strengths of the multiple signals. The value of the weighted coefficients can be selected according to the experience values of the actual system operation. By using multiple wireless signals, the interference of some sudden accidental factors (e.g. burst noise) can be reduced, the stability and robustness of the system can be enhanced and the accuracy of the recognition result can be increased.

Based on the signal strengths of the first, second and third wireless signals received by each of a plurality of devices 23, or their differences, the first determiner 213 of the wireless controller 21 determines the target device, i.e. considering the first, second and third wireless signals together and determining the target device according to them.

Preferably, the first determiner 213 can, among the devices having a relatively high third signal strength, determine the device corresponding to the first and second signal strengths having the minimum absolute of signal strength difference as the target device. Specifically, based on factors such as the transmitting antenna, the receiving antenna, the transmission environment and so on, a proper predefined threshold can be set, devices having the signal strength above the predefined threshold can be determined as devices having a relatively high third signal strength.

Moreover, according to formula (15), the first determiner 213 determines the device corresponding to the minimum weighted sum of the reciprocal of the third signal strength and the absolute difference between the first and the second signal strengths as the target device, i.e. the device having the smallest W is the target device.

$$W = {W}_{1} \cdot \frac{1}{{P}_{{Rm}^{″ ″}}} + {W}_{2} \cdot \vert {P}_{{Rm}^{″}} - {P}_{{Rm}^{′}} \vert \qquad ( 15 )$$

Wherein, m=1, . . . , M, M is the number of devices, P_{Rm′}, P_{Rm″}, P_{Rm′″} are signal strengths of the first, second and third wireless signals received by the device m respectively, W₁ and W₂ are weighted coefficients which can be selected according to the actual system. Under the circumstances that both W₁ and W₂ are 1, the device corresponding to the minimum sum of the reciprocal of the third signal strength and the absolute difference between the first and second signal strengths is the target device.

Those skilled in the art should understand that there are various ways to determine the target device based on the comprehensive consideration of the first, second and third signals. The present invention is not limited to the two aforementioned preferred embodiments. And various modifications can be made based on the two aforementioned preferred embodiments.

As a variant of the structure shown in FIG. 7, the first transmitter 211 can also comprise a third and fourth directional antenna with the same directional gain, and a third controller. The two transmitting processes of the second directional antenna 71 shown in FIG. 7 can be done by the third controller controlling the third and fourth directional antennas to send the first and second wireless signals at the same time. Obviously, if the first and second wireless signals are sent at the same time, they should satisfy the orthogonal requirement (e.g. Frequency Division Multiplex Access or Code Division Multiplex Access etc). The advantage of the solution is that it decreases the recognition process and reduces the user waiting time. The disadvantage is that it needs one more directional antenna, which will increase the cost.

It should be noted that because it is inevitable to have error in practical operation, the terms “same” or “pointing” mentioned in this description refer to quasi same or quasi pointing, i.e. approximately same or approximately pointing, and not strictly completely same or pointing.

Furthermore, distinguishing the first, second, third and fourth directional antennas is only for facilitating the description without other particular meanings. In fact, the first and second directional antennas can be the same as or different from the third and fourth directional antennas.

What is more, although the first transmitter 211, the obtainer 212, the first determiner 213 and the recognizer 22 are integrated in the wireless controller 21 in FIG. 2, in practice the first transmitter 211 can be separate from the obtainer 212 and the first determiner 213. Under the circumstances that the first transmitter 211 is separate from the obtainer 212 and the first determiner 213, the communication between the obtainer 212 and the second transmitter 233 of each device 23 can be performed in the manner of wireless communication or wire communication.

Moreover, the operating apparatus of each device 23 can be integrated in the device or be separate. For example, the device is a light, and its switch or its brightness adjustment apparatus is separate from the light.

It should be further noted that wireless signal transmission protocols of the present invention are unlimited, including ZigBee™, Bluetooth™, IEEE802.11, NFC, UWB and so on. The carrier band of wireless signals is also not limited, for example, 2.4 GHz, infrared, ultrasonic, laser etc. are all applicable for the present invention.

The embodiments of the present invention have been described above. It is to be understood that the present application is not limited to the specific embodiments described previously, and various modifications or alterations can be made by those skilled in the art within the scope of the appended claims.

What is claimed is:

1. A method for recognizing a target device, wherein the method comprises the steps of:
A. sending a first and a second wireless signals to a plurality of devices;
B. obtaining, from each device, a first and a second signal strengths respectively representing the signal strength of the first and the second wireless signals received by the device, or a signal strength difference between the first and the second signal strengths;
C. determining the target device according to the obtained signal strengths or the signal strength differences.

2. The method according to claim 1, wherein step A further comprises the following steps of:
sending the first wireless signal to the plurality of devices by an omnidirectional antenna; and
sending the second wireless signal to the plurality of devices by a directional antenna with its maximum power gain direction substantially pointing to the target device; and step C further comprises the following step of:
determining as being the target device the device corresponding to the maximum or minimum signal strength difference among all the signal strength differences or the two signal strengths having the maximum or minimum signal strength difference, wherein the two signal strengths respectively represent the first and the second wireless signals received by one common device of the plurality of devices.

3. The method according to claim 1, wherein step A further comprises the following step of:
by way of symmetrically deviating by a predetermined angle from a predetermined direction, respectively sending the first and the second wireless signals with a directional antenna; wherein, the step C further comprises the following step of:
determining as being the target device the device corresponding to the signal strength difference having the minimum absolute among all the signal strength differences or the first and the second signal strengths having the minimum absolute signal strength difference, wherein the first and the second signal strengths respectively represent the first and the second wireless signal received by one common device of the plurality of devices.

4. The method according to claim 3, further comprising the following step of:
sending a third wireless signal to the plurality of devices by the directional antenna with its maximum power gain direction substantially pointing to the target device;
wherein the step C further comprises the following step of:
C1. determining the target device according to the signal strengths corresponding to the first, the second and the third wireless signals received by each of a plurality of devices or the signal strength differences of the first, the second, and the third wireless signals received by each of a plurality of devices.

5. The method according to claim 4, wherein the steps C1 further comprises a step of:
among the devices having a third signal strength above a predefined threshold, determining as being the target device the device corresponding to the first and second signal strengths having the minimum absolute signal strength difference, wherein the third signal strength representing the signal strength of the third wireless signal received by a corresponding device of the plurality of devices.

6. The method according to claim 4, wherein step C1 further comprises a step of:
determining as being the target device the device corresponding to the minimum weighted sum of the reciprocal of the third signal strength and the absolute difference between the first and second signal strengths.

7. A wireless controller for recognizing a target device, wherein the wireless controller comprises:
a first transmitter, configured to send a first and second wireless signal to a plurality of devices;
an obtainer, configured to obtain, from each device, a first and a second signal strength respectively representing the signal strength of the first and the second wireless signals received by the device, or a signal strength difference between the first and the second signal strengths;
a first determiner, configured to determine the target device according to the obtained signal strengths or the obtained signal strength differences.

8. The wireless controller according to claim 7, wherein the transmitter comprises:
an omnidirectional antenna, configured to send the first wireless signal to the plurality of devices;
a first directional antenna, configured to send the second wireless signal to the plurality of devices, wherein the maximum power gain direction of the first directional antenna substantially points to the target device;
a first controller, configured to control the omnidirectional antenna and the first directional antenna to respectively send the first and the second wireless signals;
wherein the first determiner is further configured to:
determine the device corresponding to the maximum or minimum signal strength difference among all the signal strength differences or the two signal strengths having the maximum or minimum signal strength difference as the target device, wherein each of the two signal strengths respectively represents the first and second wireless signal received by one common device of the plurality of devices.

9. The wireless controller according to claim 7, wherein the transmitter further comprises:
a second directional antenna, configured to send the first and the second wireless signals to the plurality of devices;
a second controller, configured to control the second directional antenna to send the first and the second wireless signals by way of symmetrically deviating by a predetermined angle from a predetermined direction;
wherein the first determiner is further configured to:
determine as being the target device the device corresponding to the signal strength difference having the minimum absolute among all the signal strength differences or the first and the second signal strengths having the minimum absolute signal strength difference, wherein the first and the second signal strengths respectively represent the first and the second wireless signal received by one common device of the plurality of devices.

10. The wireless controller according to claim 9, wherein the second controller is further configured to:
control the second directional antenna to send a third wireless signal to the plurality of devices with its maximum power gain direction substantially pointing to the target device;
wherein the first determiner is further configured to:
determine the target device according to the signal strength corresponding to the first, the second and the third wireless signals received by each of the plurality of devices or the signal strength differences of the first, the second and the third wireless signals received by each of the plurality of devices.

11. The wireless controller according to claim 10, wherein the first determiner is further configured to:
among the devices having a third signal strength above a predefined threshold, determine as being the target devices the devices corresponding to the first and the second signal strengths having the minimum absolute signal strength difference, wherein the third signal strength represents the signal strength of the third wireless signal received by a corresponding device of the plurality of devices.

12. The wireless controller according to claim 10, wherein the first determiner is further configured to:
determine as being the target device the device corresponding to the minimum weighted sum of the reciprocal of the third signal strength and the absolute difference between the first and second signal strengths.

13. The wireless controller according to claim 7, wherein the first transmitter further comprises:
a third directional antenna, configured to send the first wireless signal to the plurality of devices
a fourth directional antenna, configured to send the second wireless signal to the plurality of devices;
a third controller, configured to control the third directional antenna and the fourth directional antenna to respectively send the first and the second wireless signals by way of symmetrically deviating by a predetermined angle from a predetermined direction.

14. A device comprising:
a receiver, configured to receive two wireless signals sent by a wireless controller;
a second determiner, configured to determine the signal strengths of the two wireless signals or their difference;
a second transmitter, configured to send the signal strengths or their difference to the wireless controller.

15. The device according to claim 14, wherein the receiver is further configured to:
receive a third wireless signal sent by the wireless controller;
the second determiner is further configured to:
determine the signal strength of the third wireless signal;
the second transmitter is further configured to:
send the signal strength of the third wireless signal to the wireless controller.
